(19) United States
(12) Patent Application Publication
(10) Pub. No.: US 2006/0152533 A1
(43) Pub. Date: Jul. 13, 2006

(54) Program robots with off-line design

(76) Inventor: Dale Read, London (GB)

Correspondence Address: Eckert Seamans Cherin & Mellott, 44th Floor, 600 Grant Street, Pittsburgh, PA, 15219, US

(21) Appl. No.: 10/502,006

(22) PCT Filed: Dec. 19, 2002
(86) PCT No.: PCT/GB02/05810

§ 371 Date: Aug. 1, 2005

(30) Foreign Application Priority Data
Dec. 27, 2001 (GB) 0130986.3

(51) Int. Cl. G09G 5/00

(52) U.S. Cl. 345/653

(57) ABSTRACT

A method of programming a robot for operation in a robot manufacturing facility, for example for automobile manufacture, comprises firstly, establishing sets of design data including data relating to dimensions and relative positions of parts of a robot, positions of a robot base and of product handling and transporting equipment in a manufacturing cell and design data relating to dimensions and positions of parts of the proposed product, and secondly establishing a robot program by processing that data. The robot program established comprises data and instructions for movement of defined parts of the robot for manufacturing or assembly tasks to be carried out by the robot in that manufacturing cell. The method further comprises, thirdly, operating a virtual model of the robot in a virtual model of the manufacturing cell to check operability and fourthly, after such adjustment as may be necessary to secure operability at the virtual level, operating the corresponding real robot in the corresponding real cell. The real robot and/or manufacturing cell incorporates beams for sensing the real positions of the operative part or parts of the real robot in relation to the real workpiece or product, supported by the real product handling or transporting equipment. At this stage, the method further comprises determining corrections required to bring the operative part or parts of the robot into the desired positions with respect to the real workpiece supported by the real product handling and transporting equipment in the cell, and applying these corrections to the design data originally processed to establish a revised program for controlling the real robot in the real cell.

THE PRESENT INVENTION relates to the use of robots in automated manufacture of products, such as motor vehicles.

Traditional development of robot automated manufacturing facilities required installation of the full manufacturing workstations or cells in which robots were to operate before such robots could be programmed, as until this point the paths which the operative parts of such robots would take, the positions to access and the base installation position were unknown. This meant long implementation times and many late changes in order to commission a cell.

Advances in 3D modelling software and computer hardware performance mean that these activities can now be simulated prior to any build. It is among the objects of the present invention, by taking advantage of these advances, to provide a robot programming method in which the location of robots, fixtures, conveyors and other equipment can all modelled in three dimensions and the manufacturing process, or the respective part of that process, simulated in real-time with all the correct kinematics etc., prior to building the corresponding real manufacturing facility.

Packages exist for converting offline robot simulations into code for downloading directly into robots. However these packages have certain drawbacks. Thus, as proprietary software they are expensive and each will only work with a specified manufacturer's robots. These known packages convert paths of limbs or members of the robots concerned directly to absolute coordinates, which are impossible to align correctly with the real world coordinates on installation, so that a robot program developed offline using these known packages is useless. This is compounded in multi-robot facilites. Known packages take no account of potential changes in the real world environment e.g. expansion or contraction of components or robot parts with temperature changing distances, wear and tear of tooling, increasing play and tolerance stack-ups in assembly, for example.

A need persists for software for generating robot programs for any make of industrial robot, and for a methodology for adapting program code for such robots to a real world environment.

The present invention provides a process for offline robot programming and alignment of the robot to real world co-ordinates.

Thus, in accordance with the present invention there is provided a method of programming a robot in a robot manufacturing facility comprising establishing sets of design data including data relating to dimensions and relative positions of parts of a robot, positions of a robot base and of product handling and transporting equipment in a manufacturing cell and design data relating to dimensions and positions of parts of the proposed product, establishing by processing said data, a robot program, comprising data and instructions for movement of defined parts of the robot for the manufacturing or assembly tasks to be carried out by the robot in that cell, operating a virtual model of the robot in a virtual model of the manufacturing cell to check operability and after such adjustment as may be necessary to ensure operability at the virtual level, operating the corresponding real robot in the real corresponding real cell, with means for sensing the real positions of the operative part or parts of the real robot in relation to a real workpiece or product, supported by the real product handling or transporting equipment, determining corrections required to bring said operative part or parts of the robot into the desired positions with respect to the real workpiece supported by the real product handling and transporting equipment in the cell, and applying these corrections to the design data originally processed to establish a revised robot program for controlling the real robot in the real cell.

Preferably, in the programming method of the invention, a general virtual robot program is established using, for the design data relating to the robot, parameters common to a plurality of different robots suitable for use, or even using only coordinates describing positions and orientations of a robot tool in a reference frame fixed with respect to the factory space local to the cell concerned and a program suitable for a specific robot is determined by applying to said general program a program header specific to that robot and defining parameters in that general program in terms of known design parameters specific to the particular robot concerned.

In the preferred method in accordance with the invention, the programming process takes raw data exported from a 3D simulation of a robot process as a set of point location co-ordinates. This data is then run through a novel and inventive robot program development tool (i.e. a computer program operable to produce software, namely a robot program), to create a program for a specific make or model of robot. This program is then available for download to the shop floor robot ready for execution.

As will be appreciated from the above, to enable the shop floor robot to apply the auto-generated program to specific vehicles, it is necessary for the robot to find particular vehicle points in ‘space’. In preferred embodiments this is done using an integrated laser recognition system which, in conjunction with the offline program generator and the physical robot makes it possible to overcome production, installation and manufacturing errors. The whole package is operable, in the preferred embodiment, to achieve true offline adaptable robot programming for production quality results.

A preferred embodiment of the invention is described below with reference to the accompanying illustrations in which:—

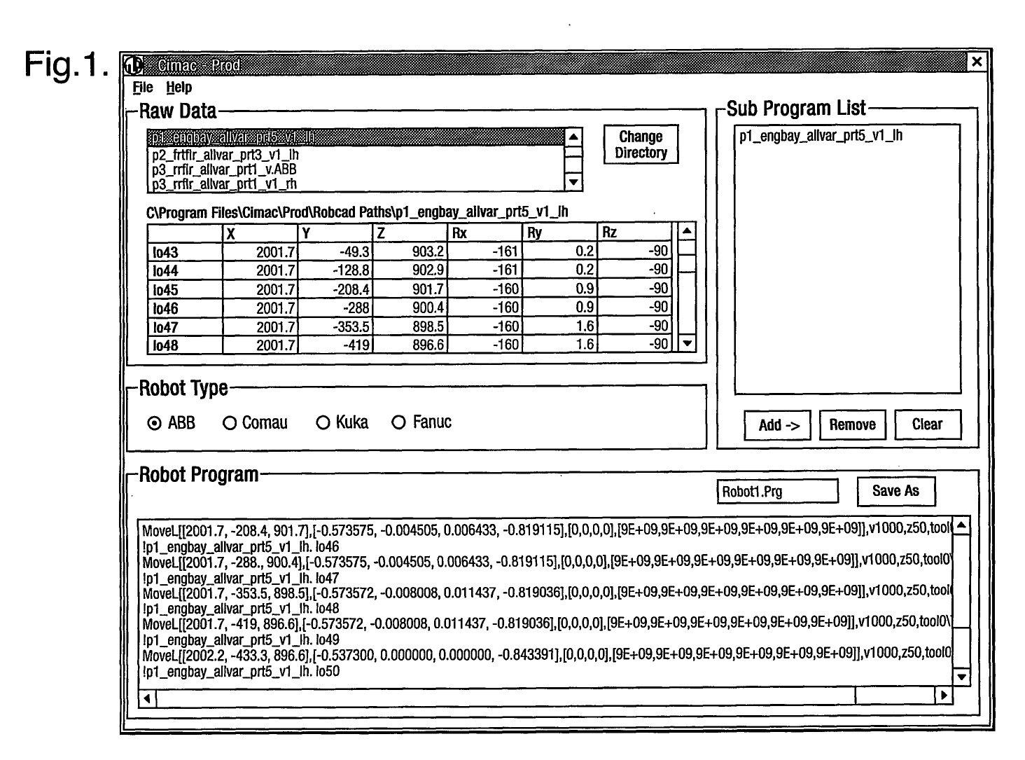

FIG. 1 shows a visual display provided on a video display unit during operation of a computer-based program development tool embodying the invention, and

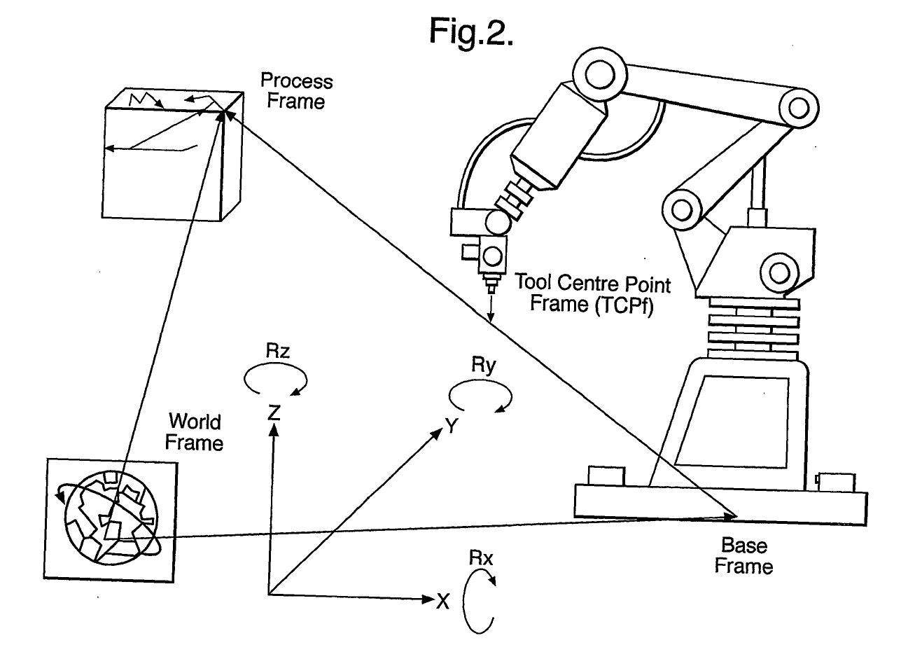

FIG. 2 is a diagrammatic illustration of a robot and the specification of positions of a tool carried by or forming part of the robot in frames of reference, in terms of numerical coordinates.

In the preferred method embodying the invention, data is exported from 3D Simulation software (such as eMPower/Robcad or Deneb) as an ASCII text file. This file contains definitions of a set of locations making up a robot path, each location being denoted as ‘loNN’ where NN is the location number. The definitions include the X, Y and Z co-ordinates of the Tool Centre Point (TCP) and rotations Rx, Ry and Rz which define the angular orientation, and hence, usually, the approach angle of the tool to this point. The origin for the Cartesian co-ordinates is a known point, usually referenced from the centre of the robot baseplate as positioned within the simulation frame, and the X,Y and Z axes are likewise known axes.

A computer running a program development software tool in accordance with the invention, (this tool also being referred to herein as the PROD program), operates upon the text file referred to. More particularly, the text file is selected from within the PROD program and the six co-ordinates, (X,Y,Z, Rx, Ry and Rz), for each point are displayed in a table in a window on the computer VDU or monitor, (see FIG. 1). The user selects the required robot type from the options given in this window, (referred to herein as the PROD window), e.g. ABB, Comau, Kuka, Fanuc etc.

The PROD program transforms the simulation location co-ordinates and angles into a new set of co-ordinates understood by the selected robot. In general, the X,Y and Z co-ordinates of the Tool Centre Point remain unchanged, but the positions of all the robots axes to get the tool to approach each point correctly must be defined differently for different robots, for example IN quaternian coordinates based on hypercomplex equations, or Euler A, E and R angles as required.

For each step the PROD program adds an appropriate header and footer for the specific robot type selected, thus building the converted co-ordinates into a robot language program. This is then saved in a format appropriate for downloading direct to the robot controller. Sub programs can be created for path sections that enable them to be called with one command.

A robot control program created using only the steps described above would guide the robot through a path exactly as specified in the virtual simulation environment. However this would not necessarily guarantee an accurate production process. Various errors may be present unavoidably owing to normal variations from nominal positions, including:
(a) Installation error, which results from the tolerances of installation, i.e., from the fact that the robot base plate is not quite in precisely the position the designer of the manufacturing cell or workstation intended. Installation error may also exist in the installation position and gradient, i.e. slope, of product transfer equipment, e.g. of conveying and product indexing equipment for moving workpieces such as partially finished vehicles through the workstation and from workstation to workstation.
(b) Manufacturing error, which results from the tolerances of machining and assembling components into completed pieces of equipment. For example, the Tool Centre Point may be slightly different in distance from the centre of the robot wrist than intended by the designer. Manufacturing error may also be present in the height of conveyor roller beds, carriers, etc.

In operation of the present invention, both of the above errors are corrected by making measurements in the installed state and re-calibrating the equipment accordingly. The programmer does not see these errors as they lie in the background of the calculations. Measurements are taken using laser sensors actually installed on the robot to calculate the exact working offsets and end-points. This avoids the introduction of further manual measurement error.
(c) Production build error, which results from normal variability in the manufacturing process. For example, in the manufacture of motor cars, all the individual pressed panels, which may have dimensions which differ slightly from the nominal dimensions, are welded together in processes which are subject to variability and are then sent through various ovens etc. at different controlled temperatures. This means that each bodyshell, although nominally identical, is actually different and so the points on the vehicle which the robots must access will be in different locations relative to a given reference/origin than on a nominally perfect vehicle. This reference, referred to in automobile manufacturing as the car-line, is a set of co-ordinates internal to the vehicle for product design purposes. The car line origin will also move laterally or rotationally with the vehicle as the carrier skids shift on the conveyor.

The production build error requires a more complicated correction process but such a correction process is necessary for the automotive manufacturer to be satisfied with the results of robot automation. A problem with the car-line reference is that it is a virtual point in space rather than a physically locatable point. The individual paths are therefore worked out in a process frame local to the operating area. In the virtual world the process frame is referenced to at least two locatable points on the body shell using customer product CAD data, for example the edges of a bodyside door aperture.

In the installed cell, the robot uses laser displacement sensors to locate the same points in real space. This determines the physical position and orientation of the process frame relative to the robot. The robot can now execute its program with the measured offsets and thus follows the correct path for the situation presented to it. The locating process is described in co-pending UK Patent Application No. 0125079.4, but essentially uses a laser displacement sensor set to trip at a certain distance. The robot axis values at the tripping point give the position of the measured surface. The robot executes a sequence of manoeuvres to find a plane, then an edge, then homes in to a point. The first movement is always the same but each following step depends on the result of the preceding one.

The real robot positions are fed back into the simulation to update the virtual environment to the real installation. Robot bases and Tool Centre Points are moved so that the virtual model reflects reality. The simulation is then accurate for future work as offline programmers will be working with the real situation. This mininises the possibility for mistakes such as asking robot axes to work outside their operating limits owing to wrong baseplate location.

Modifications to the path, made and verified offline, can then be converted and typed directly into the robot program with confidence. Any points that are identified as unreachable can be highlighted and suggestions put forward for rectification, long before the problem would emerge on the shopfloor.

Benefits of the present invention includes:—

Reduction of on-site robot programming;

Accelerated commissioning of automation cells;

Effective use of CAD design data in implementation of cells;

Elimination of duplicated operations in virtual and physical environments;

Reduced product time to market.

Additionally, the present invention makes it possible to make modifications during production time, with feedback of data from the real to the virtual environment. Furthermore, the invention, in its preferred form, supports operation of a mixed model factory, since it is possible to design-in cross-platform compatibility. The invention likewise makes possible so-called soft re-tooling by robot reprogramming only and reduces the cost of developing a manufacturing facility. The ability to get manufacture right first time minimises cost. There is a reduction in the need for warranty and rework tasks, i.e. a reduction in the need for rectification, under warranty, of defects in vehicles which have already left the factory, and for corresponding rectification of defects detected in vehicles before they have left the factory.

Providing for 3D simulation of the manufacturing process before a commitment is made to real world manufacture is also extremely valuable.

1. A software application to generate programs for any robot type from paths pre-determined in 3D design and simulation tools.

2. A methodology for adapting offline simulation programs to the real-world environment to counter installation, manufacturing and production errors.

3. A method of programming a robot for operation in a robot manufacturing facility, comprising establishing sets of design data including data relating to dimensions and relative positions of parts of a robot, positions of a robot base and of product handling and transporting equipment in a manufacturing cell and design data relating to dimensions and positions of parts of the proposed product, establishing by processing said data, a robot program, comprising data and instructions for movement of defined parts of the robot for the manufacturing or assembly tasks to be carried out by the robot in that cell, operating a virtual model of the robot in a virtual model of the manufacturing cell to check operability and after such adjustment as may be necessary to ensure operability at the virtual level, operating the corresponding real robot in the real corresponding real cell, with means for sensing the real positions of the operative part or parts of the real robot in relation to a real workpiece or product, supported by the real product handling or transporting equipment, determining corrections required to bring said operative part or parts of the robot into the desired positions with respect to the real workpiece supported by the real product handling and transporting equipment in the cell, and applying these corrections to the design data originally processed to establish a revised robot program for controlling the real robot in the real cell.

4. A method according to claim 3 in which, firstly, a a general virtual robot program is established using, for the design data relating to the robot, parameters common to a plurality of different robots suitable for use, or even using only coordinates describing positions and orientations of a robot tool in a reference frame fixed with respect to the factory space local to the cell concerned and a program suitable for a specific robot is determined by applying to said general program a program header specific to that robot and defining parameters in that general program in terms of known design parameters specific to the particular robot concerned.

5. Apparatus for use in programming a robot for use in a manufacturing cell in a manufacturing facility, including sensing means for sensing the real positions of an operative part or parts of the robot in relation to a real workpiece, and for relaying the resulting positional information back to a control facility controlling the robot in accordance with pre-programmed parameters, said control facility including computing means running a program such that the control facility is arranged to adjust said parameters so as to minimize discrepancies between the real and design positions of said operative part or parts relative to the tool.

6-7. (canceled)
